(19) United States
(12) Patent Application Publication
(10) Pub. No.: US 2021/0189786 A1
(43) Pub. Date: Jun. 24, 2021

(54) SOLAR CASEMENT WINDOW CONTROL DEVICE

(71) Applicant: WIFI Power Windows Corp., Vars (CA)

(72) Inventors: Allan Cantor, Ottawa (CA); Dominic Jacques, Vars (CA); Christopher Pearen, Brampton (CA); Ron Thatcher, Bond Head (CA)

(73) Assignee: WIFI Power Windows Corp., Vars (CA)

(21) Appl. No.: 17/114,564

(22) Filed: Dec. 8, 2020

Related U.S. Application Data
(60) Provisional application No. 62/950,566, filed on Dec. 19, 2019.

(51) Int. Cl. E05F 15/71; E05F 15/614; F16H 1/14; H04B 1/40

(52) U.S. Cl. CPC E05F 15/71; E05Y 2900/148; F16H 1/14; H04B 1/40; E05Y 2201/434; E05Y 2201/71; E05Y 2400/32; E05Y 2400/40; E05Y 2400/44; E05Y 2400/45; E05Y 2400/614; E05Y 2400/664; E05Y 2400/82; E05Y 2600/502; E05Y 2600/45; E05Y 2800/70; E05F 15/614

(57) ABSTRACT

A solar-powered window control device having a photovoltaic cell for powering automated window opening and closing. The device can be retrofitted onto any exterior exposure gear-driven mechanism without requiring special skills for installation. A wireless-enabled motorized window control for opening and closing the window is contained within a single enclosure and mounts by engagement with an existing window's operator gear and casement operator and can be controlled with a microcontroller for smarthome integration.

### CROSS-REFERENCE TO RELATED APPLICATIONS

This application claims priority to U.S. provisional patent application 62/950,566 filed 19 Dec. 2019, which is hereby incorporated by reference herein in its entirety.

### FIELD OF THE INVENTION

The present invention pertains to a solar-powered window motorized control device for a casement window. The window control device can be incorporated into a new window or retrofitted to an existing casement window crank.

### BACKGROUND

With advances in electronics and wireless systems, smart devices are being used more and more for controlling aspects of security and the indoor environment. The internet of things has enabled connectivity and integration of previously analog devices and many popular home automation devices are already in widespread use including lights, thermostats, audio and video systems, door locks, and security systems.

Traditionally, windows and doors are opened and closed manually for providing exterior ventilation to an indoor space when weather is good. Security, weather, and energy concerns may require adjustment or closing of the window entirely. Casement windows are one of the most energy-efficient window types as the sash creates an airtight seal against the window frame when closed. Casement windows also provide air control into the house due to ventilation opening from the side. An automatic method of opening casement or awning windows is desirable to ease labour, enable control of difficult-to-reach openings, and to operate windows programmatically and in a concerted way according to a schedule or environmental sensor readings.

Many variations on automatic window openers now exist which require modification of the window or window frame to varying degrees. In some cases, the opener must be connected to a home's electrical system (mains power), which requires an electrician to complete the installation. In many cases the window operator must be removed for a retrofit, which may require a trained installer. The operator is a mechanism that opens and closes a casement or awning window, consisting of the handle, shaft, gears, levers and mounting brackets. One example of a gear-driven automated window or door system is described in United States patent application US20190003236A1 to Hall et al. which provides a motorized window with one or more motors and a frame with a slidable segment and gear track which is mounted to the window or door frame and engaged with a slidable segment.

There remains a need for an automated and electronically connected opening and closing mechanism for a casement window that can be easily installed onto casement windows.

This background information is provided for the purpose of making known information believed by the applicant to be of possible relevance to the present invention. No admission is necessarily intended, nor should be construed, that any of the preceding information constitutes prior art against the present invention.

### SUMMARY OF THE INVENTION

An object of the present invention is to provide an automated and electronically connected opening and closing mechanism for a casement window that can be easily installed onto casement windows. Another object of the present invention is to provide a solar powered casement window control device that can be used in a smart home installation.

In an aspect there is provided a device for adjusting the angle of a casement window comprising: a gear control mechanism comprising a spline shaft for engaging with an operator gear on a casement window; a motor operably connected with the gear control mechanism to move the gear control mechanism and the operator gear to adjust a window angle of the casement window; a photovoltaic cell; a battery connected to the photovoltaic cell for storing energy produced by the photovoltaic cell and for powering the motor; a microcontroller for controlling the motor; and a wireless transceiver in communication with the microcontroller to direct the microcontroller to control the motor and adjust the angle of the casement window.

In an embodiment, the device further comprises one or more sensor operably connected to the microcontroller.

In another embodiment, the sensor is an indoor temperature sensor, outdoor temperature sensor, humidity sensor, light intensity sensor, window position sensor, window status sensor and window obstruction sensor

In another embodiment, the device further comprises a screen displaying one or more sensor output, battery status, window position, window status, outdoor temperature, indoor temperature, and weather.

In another embodiment, the device is a retrofit to an existing casement window.

In another embodiment, the device further comprises a clamp for securing the device to a casement operator.

In another embodiment, the motor has a variable motor speed to apply varying torque to the gear control mechanism.

In another embodiment, the device further comprises a current sensor to detect when a change in torque applied by the motor is required.

In another embodiment, the microcontroller is integrated with a smart-home technology through a local wireless network.

In another embodiment the device further comprises an AC power adaptor to charge the battery.

In another embodiment, the wireless transceiver operates using bluetooth, radiofrequency control, or remote data transmission.

In another embodiment, the gear control mechanism comprises two spline shaft engagement gears, one of the spline shaft engagement gears for controlling a clockwise-opening casement window and the other spline shaft engagement gear for controlling a counter-clockwise-opening casement window.

In another embodiment, the device further comprises an encoder wheel and optical sensor for detecting the window angle.

In another aspect there is provided a method of adjusting the angle of a casement window comprising: collecting solar energy using a photovoltaic cell; storing the collected solar energy in a battery; and powering a motor engaged with a gear control mechanism coupled to an operator gear on the casement window to adjust the angle of the casement window.

In another aspect there is provided a method of adjusting the angle of a casement window comprising: collecting solar energy using a photovoltaic cell; storing the collected solar energy in a battery; coupling a gear control mechanism comprising a spline shaft with an operator gear on the casement window; and powering a motor operably connected with the gear control mechanism to adjust the angle of the casement window.

In an embodiment, the method further comprises detecting an environmental condition using a sensor and adjusting the angle of the casement window based on data detected by the sensor.

In another embodiment, the method further comprises receiving weather data from a wireless network and adjusting the angle of the casement window based on the received weather data.

In another aspect there is provided a kit for retrofitting an existing casement window comprising: a clamp for securably clamping to a casement window operator; a spline shaft; a device for adjusting the angle of a casement window comprising: a gear control mechanism for engaging with the spline shaft and the operator gear on the casement window; a motor operably connected with the gear control mechanism; a photovoltaic cell; a battery connected to the photovoltaic cell for storing energy produced by the photovoltaic cell and for powering the motor; a microcontroller for controlling the motor; and a wireless transceiver in communication with the microcontroller to direct the microcontroller to control the motor and adjust the angle of the casement window.

In an embodiment of the kit, the clamp is a universal clamp capable of adjusting to a plurality of sizes of casement window operators.

In another embodiment, the kit comprises a plurality of spline shafts for engaging with a variety of sizes of operator gear.

### BRIEF DESCRIPTION OF THE FIGURES

For a better understanding of the present invention, as well as other aspects and further features thereof, reference is made to the following description which is to be used in conjunction with the accompanying drawings, where:

FIG. 1 is an isometric view of a solar-powered window control device mounted to a window frame;

FIG. 2 is an exploded view of one embodiment of the solar-powered window control device;

FIG. 3 is an isometric view of a solar-powered window control device;

FIG. 4 is an exploded close-up view of a solar-powered window control device;

FIG. 5 is a cross-sectional side view of a solar-powered window control device;

FIG. 6A is an isometric view of a gear frame assembly for a solar-powered window control device;

FIG. 6B is an isometric view of a spline shaft for engagement of the gear mechanism of a casement window with the solar-powered window control device;

FIG. 7 shows an isometric view of a motor assembly;

FIG. 8 shows an isometric view of an installation clamp;

FIG. 9 is an isometric view of the window control device with detached motor housing;

FIG. 10 is an example of a graphical user interface that can be used to monitor data from and issue instructions to the solar-powered window control device;

FIG. 11 is an example of an electrical schematic showing connectivity within the solar-powered window control device;

FIG. 12A is an isometric view of a bevel gear mechanism and window angle sensor; and

FIG. 12B is another isometric view of a bevel gear mechanism and window angle sensor without the casing.

### DETAILED DESCRIPTION OF THE INVENTION

Unless defined otherwise, all technical and scientific terms used herein have the same meaning as commonly understood by one of ordinary skill in the art to which this invention belongs.

As used in the specification and claims, the singular forms “a”, “an” and “the” include plural references unless the context clearly dictates otherwise.

The term “comprising” as used herein will be understood to mean that the list following is non-exhaustive and may or may not include any other additional suitable items, for example one or more further feature(s), component(s) and/or element(s) as appropriate.

The term “signal”, as used herein, includes but is not limited to one or more electrical, optical, or digital signals comprising data. The signal used by the one or more computer or processor instructions, messages, a bit or bit stream, or other means that can be received, transmitted and/or detected.

The terms “operator” and “casement operator”, as used herein, refer to a mechanism that opens and closes a casement or awning window which comprises an operator gear shaft, one or more gears, and one or more levers or lever arms for engagement with a window. The lever of an operator is generally slidably attached to a window on a track mounted to the window such that rotation of the operator gear shaft changes the angle of the lever relative to the window frame to open or close the window.

The term “casement window” as used herein refers to a window that is attached to its frame by one or more hinges at the side. Casement windows can be mounted singly or in pairs within a common frame, in which case they are usually hinged on the outside. Modern casement windows are opened using a gear mechanism or operator to adjust the angle of the window relative to the window frame.

Herein is described a solar-powered window control device for automated window opening and closing. The presently described device provides an automatic opening and closing mechanism for a casement window or other gear-driven device with exterior exposure that can be installed onto existing windows or retrofit without requiring special skills for installation. A wireless-enabled motorized window control for opening and closing the window is contained within a single enclosure and mounts by engagement with an existing window's operator gear and casement operator resulting in easy installation for an average consumer. This solution is low cost, requires no alteration of the existing frame, is suitable for installation by a lay person, and is suitable for use in home and commercial buildings. A solar energy collector can be used to collect power which can be used to power the present gear-driven device. Power to the window control device can be provided by the solar panel solar charged batteries with an optional AC adapter for power supplementation, with all electrical components and wires contained within a single enclosure. One or more solar panels integrated into the solar-powered window control device increase its energy efficiency and can recharge the batteries sufficiently to reduce or remove the need for an external power source.

Additionally, sensors integrated into the device can collect data to communicate and integrate with a smart home system to enable decision making regarding the open/close state of the window. Additional data gleaned from the internet such as, for example, season, location, and weather data, can be used to inform the smart home system. Sensors in the device can also include one or more indoor temperature sensor, outdoor temperature sensor, wind speed sensor, humidity sensor, light intensity sensor, window position sensor, window status sensor (to detect whether the window is locked or unlocked), and window obstruction sensor. Other smart home data such as occupancy, thermostat data, and the preferences of the user can also be used to control the window state to provide an optimal interior environment as well as home security. These features, optionally in combination with artificial intelligence, can be used to provide automated window function in an energy efficient manner.

The presently described window control device can be accessed remotely via, for example, bluetooth or Wi-Fi to a computer, computing device, and/or cellphone, and can be connected to a smarthome system or thermostat, with conserved manual operation with a manual input while the device is attached. Feedback can also be provided by the device to indicate the temperature, humidity, battery level, the window's position, and whether the window is locked. Installation does not require special training or tools and is possible solely from inside the house or building. Installation further does not damage the existing window and is compatible with standard casement and awning windows.

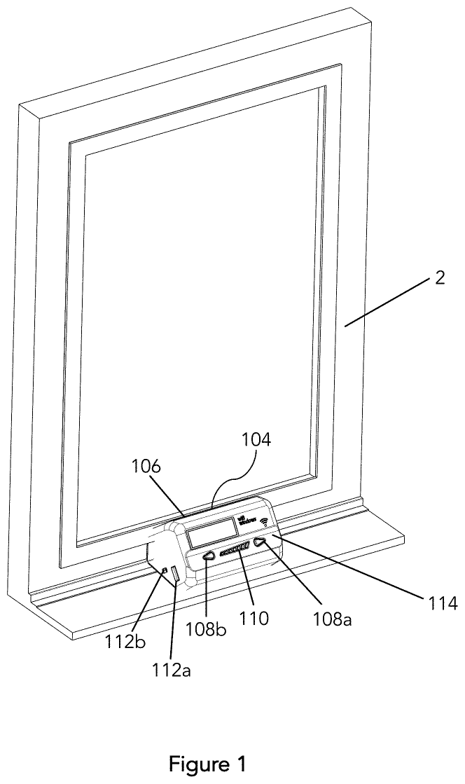

Referring now to the Figures, FIG. 1 shows an isometric view of a solar-powered window control device 104 mounted to the interior side of a window frame 2. The window frame 2 may be a new frame ready for installation or an existing frame already installed that can be retrofit with the present device. The solar-powered window control device comprises a solar panel 106 mounted on the solar-powered window device chassis, which, in the depicted embodiment faces outward and angled towards window exterior and the sunlight. Optionally, more than one solar panel 106 can be connected in series, optionally with the positive and negative terminals connected to the input of a maximum power point tracking module to maximize power extraction under all conditions. In the embodiment depicted in FIG. 1, one or more manual controllers 108a, 108b in the form of a button are capable of receiving manual input regarding whether to open or close the window and how much. In one embodiment, one manual controller can be provided to open the window (such as a right arrow) and one manual controller can be provided to close the window (such as a left arrow). Providing a means for manual operation provides additional safety and reliability. Furthermore, manual operation can permit an easy and safe way for the user to calibrate the device by specifying when the window is in a fully open and fully closed position, which could then be recorded by the device. A light display 110 functions as a built-in user notification for visual feedback about user commands and solar-powered window control device 104 status. An additional optional display on the top of the device can provide status information on the operation of the device, such as the amount that the window is opened or closed. One or more ports 112a, 112b can also be provided for charging and/or data transfer, which may be a USB or other data or power transfer port. In another embodiment, the charging and data transfer ports may be separate, or there may be multiple data transfer ports, or other combinations thereof. Optional apertures in the device housing 114 and chassis can be used to provide ventilation to the device. After attachment of the solar-powered window control device 104 to the operator on the window, the device may be operated manually through a manual controller, for example at least one button on the device, or by remote control or wireless control, for example through a computer or cell phone or smarthome controller device. Remote communication with the window controller device can be managed via a wireless transceiver component and the signal may be mediated by bluetooth, wi-fi, any other suitable wireless communication mode.

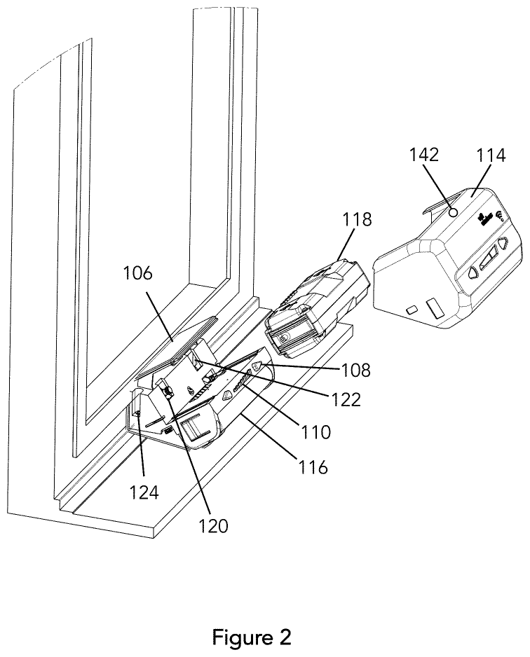

FIG. 2 is an exploded view of one embodiment of the outer device housing, the gear housing, and the chassis that fit together to complete the solar-powered window control device. The device housing 114, the gear housing 118, and the chassis 116 fit together to complete the solar-powered window control device in a simple assembly process, which may be facilitated by fitted pieces that slide and/or clip together optionally with guides and complementary pins and apertures in each of the main components. In the depicted embodiment the gear housing 118 is reversible and can be flipped 180 degrees to match a left-hand casement gear aperture 120 or right-hand casement gear aperture 122. In other embodiments, the design of the gear housing 118 may fit a centrally positioned operator gear or may be adaptable to fit an operator gear in different locations on the casement operator. In this way a single device can be adaptable to a wide range of configurations of the casement operator. Chassis 116 is a frame that supports the components of the window device including the solar panel 106, manual controller 108, light display 110, battery housing, and attaches to a clamping plate that is secured by at least one connector 124 to the chassis 116. The connector 124 that connects the operator to the chassis 116 can be, for example, a screw, bolt, clamp, or combination thereof. In the depicted embodiment, the solar-powered window control device 104 clamps to the existing casement operator 10 without requiring any modification or retrofit of the window frame. In addition, the device can be installed and removed in a completely non-destructive manner without requiring or causing any changes whatever to the existing operator casement or window or window frame.

The chassis 116 can also connect to and secure other components that enable the secure attachment and function of the device, including one or more sensor 142, gear housing 118, and other electronical and electronic components. In another embodiment, the solar-powered window control device can be attached through friction or other means to the operator, without requiring any connectors. As shown, the gear housing 118 fits snugly into the chassis 116 to interface with the operator gear. Additional structural support can be provided by matched complementary tongues, grooves, and clips in the chassis 116 and associated parts that together provide easy assembly and strong structural support for the mechanical action of the solar-powered window control device. The depicted tongues, grooves, and clips are a subset of an example configuration, and in no way limit the combination, number, or placement of such supports.

The device may include one or more sensors 142 to provide feedback to indicate environmental conditions such as temperature, humidity, or other conditions, the status of the window including but not limited to its position and locked status, and the status of the device including but not limited to battery level. Other sensors may comprise but are not limited to at least one pressure sensor, liquid water sensor, air composition sensor, battery level sensor, location sensor (e.g. GPS), potentiometer, current sensor, and other types of sensor. Where relevant, sensors can be included to measure both interior and exterior conditions. Window locked status and position can also be determined through a current sensor, optionally one that is used to monitor the torque on the motor, which, because the current drawn by the motor increases with the demanded torque, can indicate when the device is fully open, closed, locked, or obstructed. Window position information can additionally or instead be determined by a potentiometer, or other sensors. The sensors involved in position detection additionally provide safety for the device, window, and user, and can also be connected to one or more automatic braking features to ensure that the window is only enabled to change positions when there are no obstructions in the way.

Information collected by the one or more sensors 142 may be made available to the user through a display on the unit device and/or via wireless connectivity to another device with a display, such as, for example, a smarthome display screen, computer, smartphone, or thermostat. In another embodiment, the device or connected computer can process data from the sensor and incorporate sensor data with other data using artificial intelligence to enable decision making based on sensor data and device actions without a requirement for additional user input. Sunlight can be collected from inside by the solar panel with a photovoltaic cell through the window and/or the window screen. The amount of obtainable sunlight can be limited by weather, orientation, and obstacles, shadows from trees, window awnings, buildings, etc. The maximum power point of a solar panel fluctuates with the amount of sunlight being collected. As the amount of sunlight varies, the load characteristic that gives the highest power transfer efficiency changes, so the efficiency of the system is optimized when the load characteristic changes to keep the power transfer at highest efficiency. This load characteristic is called the maximum power point (MPP). Maximum power point tracking can be used with the present device to adjust the load on the photovoltaic (PV) solar panel, changing the output voltage, and providing a means to collect power more efficiently. One or more solar panels can be connected in series, with the positive and negative terminals connected to the input of an MPP tracking module. Electrical circuits can be designed to present arbitrary loads to the photovoltaic cells and then convert the voltage, current, or frequency to suit other devices or systems, and MPP tracking solves the problem of choosing the best load to be presented to the cells in order to get the most usable power out. To ensure that no current flows from the batteries to the MPP tracking module and solar cells, a diode can be placed between the module and the battery.

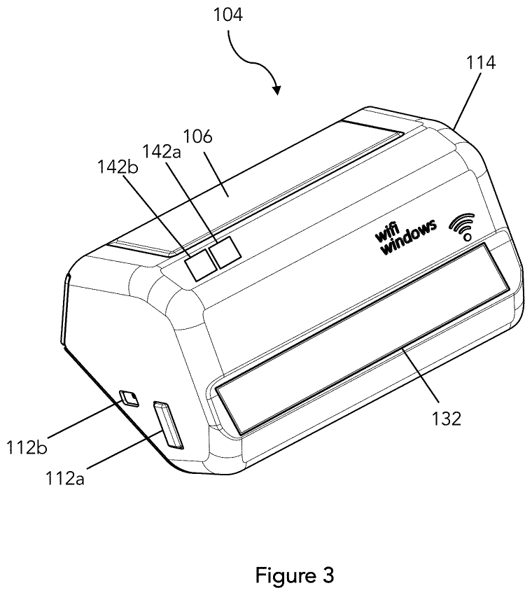

FIG. 3 is an isometric view of an assembled solar-powered window control device 104 with the solar panel 106 clearly visible. All electrical components are contained within the device housing 114, which is mounted to an existing operator gear and casement operator without modification of the existing casement gear, casement operator, or window frame. Optional apertures in the device housing 114 can be used to provide ventilation to the inside of the device. Optional sensors 142a and 142b can sense, for example, light level, humidity, temperature, motion, light level, sound, or other environmental factors that are useful for smarthome feedback and internal environmental or security control. Optional adaptors 112a, 112b can connect to an external batter or power supply or data supply or other electrical or electronic device. Optional screen 132 can display data such as but not limited to temperature, humidity, clock, battery level, window position, and other information.

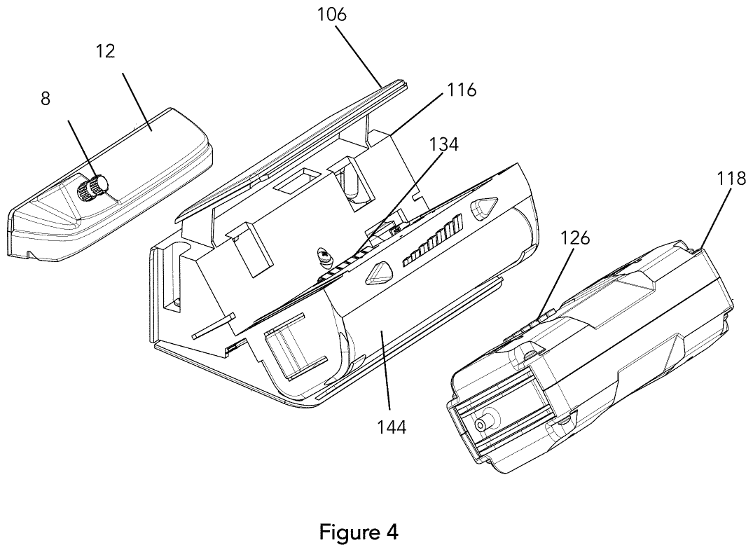

FIG. 4 is an exploded close-up view of a solar-powered window control device. The device operably and mechanically connects to a casement operator having an operator gear 8, shown here including operator cover 12 which houses and protects the operator gear 8. During installation it is preferable if any operator cover is removed so that the chassis clamp can be securely clamped onto the operator. In the depicted embodiment, the chassis 116 clamps onto the casement operator via at least one installation screw which is contained within the solar-powered window control device and does not interface directly with the existing window frame 2 or casement operator gear 8. In the depicted embodiment, one or more electrical contacts 126 are present on both top and bottom of the gear housing 118 to support left-right reversibility of the device by rotating the gear housing 118 by 180 degrees prior to insertion. The one or more electrical contacts 126 on gear housing 118 interface with and electrically connect with the contact pads 134 on the chassis 116 to electrically connect with the battery inside battery housing 144. Solar panel 106, often referred to as a photovoltaic cell, collects light energy from the sun and is also electrically connected with the battery. In the depicted embodiment, the chassis 116 includes a lip that secures the gear housing 118 when it is inserted. Additional mechanisms to secure the gear housing 118 while keeping installation simple could comprise fitted surfaces, clips, flanges, posts, dowels, tongues and grooves, and other mechanisms. The window control device can also have an optional power switch to provide an electrical power shutoff.

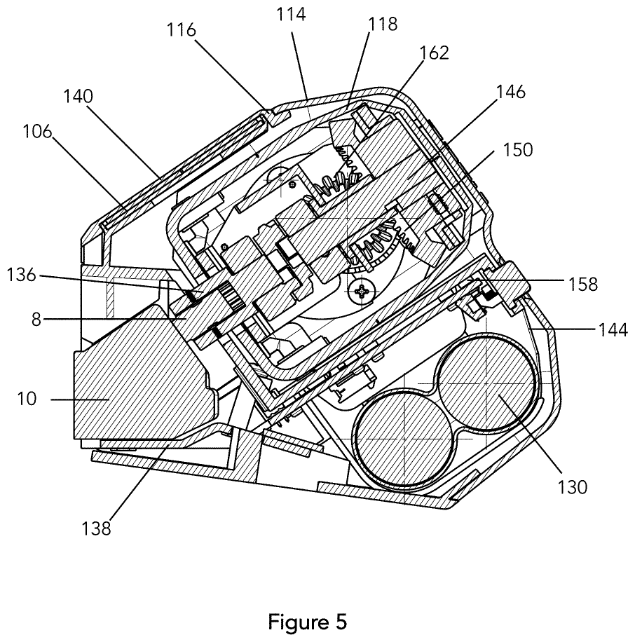

FIG. 5 shows a cross-sectional side view of an assembled solar-powered window control device with the interior components in one embodiment of the device. As embodied, the assembled device comprises a device housing 114, chassis 116 to support the device components, battery housing 144, and a gear housing 118 with all of its interior components. The gear housing 118 is shown attached to an operator gear 8 of a casement operator 10. The spline shaft 136 of the gear system is shown in cross-section fitting over casement gear 8. An installation clamp 138, which in this embodiment is metal but could be made of other materials, is shown pressing against the bottom of the casement operator 10, which is sandwiched between the installation clamp 138 and the chassis 116. In this embodiment, the solar panel 106 comprises at least one photovoltaic or solar cell and has an optional transparent solar panel cover 140. In the gear frame assembly 146 the motor gear 162 sits perpendicular to and drives the drive shaft gear 150. At least one solar cell can be a source of power both for charging the batteries and powering the device. Power can also be supplied via AC adapter, which may be a USB connector, and the device can be charged by connecting the USB charging cable to the USB port charge the window opener. Preferably, when charging, a light on the opener display will blink as the battery charges. The battery housing 144 comprising at least one battery 130 provides power to the microcontroller 158 and the motor. Microcontroller 158 comprises a motor driver, and connects to the one or more sensors to control the motor. A transceiver receives remote input from the user or automated system and directs the opening and closing of the window using the device by communication with the microcontroller 158. Providing feedback to the user is also a desirable feature. Microcontroller 158 is preferably a programmable microcontroller. With or without solar powered operation, an energy conservation mode can permit the device to last longer without charging. The microcontroller and connected circuitry should consume minimal power. This can be achieved by programming the device to run on sleep mode when no command or inquiry is issued by the user for a suitable time, conserving energy. Once an action or update is required, the device can switch back to normal running mode.

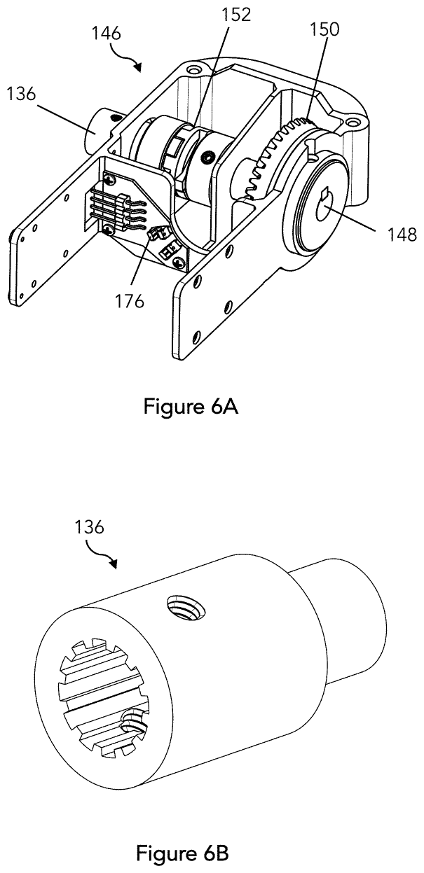

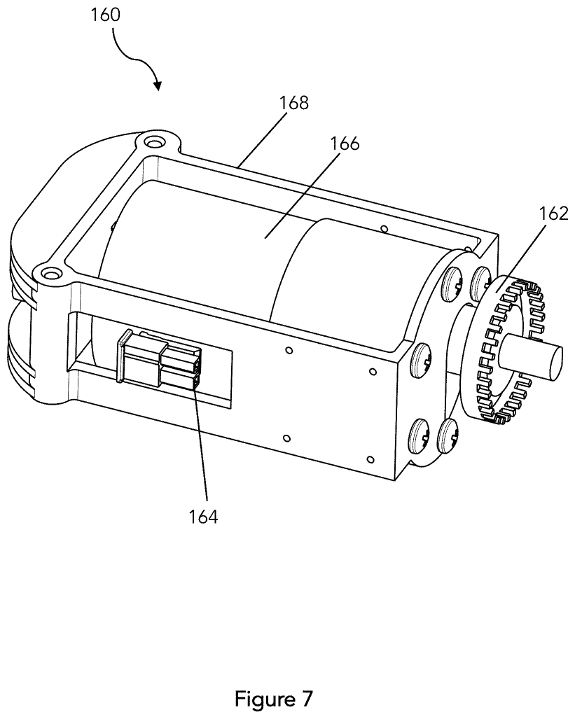

FIG. 6A is an isometric view of a gear frame assembly 146 for a solar-powered window control device, which attaches to an existing operator gear to drive window opening and closing. The motor drives the drive shaft gear 150 to turn the drive shaft 148, which is connected through a flexible spline shaft coupling 152 to the spline shaft 136 that fits onto the casement window gear 8. One consideration in the function of a solar-powered window control device is the torque demands for various casement windows. The average torque required to move the operator gear 8 differs between windows, and torque demands can fluctuate as the drive shaft 148 turns to open or close a window. Torque spikes can consistently occur at certain degrees of rotation due for example to rust, dirt, misalignment, damaged gears, or other reasons. In one embodiment, to mitigate considerations such as motor stalls and reduced motor life span, a motor with a rated torque greater than or equal to 1.27 Nm is used. Additional friction reduction modifications such as roller bearings, for example, may be used to reduce friction in the gearbox, reducing the torque and increasing efficiency and lengthening motor lifespan. To support the considerable force generated by the motor on the casement gear 8, the casing can comprise features including clips and fitted slots to firmly position the motor inside the chassis 116 and device housing 114.

Monitoring of the window's position enables calibration of the solar-powered window control device to work with different windows, and for reliable function of the solar-powered window control device. Torque nearly doubles as the window reaches a tightly closed or fully open position, which can serve as an indicator of window positions. Window position can be monitored, for example, using an optical sensor 176 and encoder wheel, by a potentiometer or an encoder with measured pulses per rotation, or by a current sensor which can provide additional position detection and safety for the device, window, and user. Using these or other means of monitoring, the described solar-powered window control device 104 can open and close casement and awning type windows fully or part way, for example by 25%, 50%, 75%, or other amounts. Typical casement windows require approximately five turns of the operator gear to fully open, and awning windows generally require ten turns. If an appropriate window opening period of 15 seconds is applied, the motor selected should have a speed of at least 20 rotations per minute (RPM) to open a casement window, and double this for an awning.

FIG. 6B is an isometric view of a spline shaft 136 for engagement of the gear mechanism of a casement window with the solar-powered window control device. The spline shaft 136 fits onto the operator gear of a casement window and can come in a wide variety of sizes to accommodate various sizes of casement gear. A kit with the described solar-powered window control device may be provided with one or more spline shafts in common sizes for connecting and retrofitting existing casement windows such that the kit purchased by the consumer can come with a correctly sized spline shaft.

FIG. 7 is an isometric view of a motor assembly 160. The motor 166 is contained within the motor housing 168 and drives the motor gear 162. Power is conducted to the motor through the battery plug 164. While a DC motor is capable of handling torque spikes higher than its rating for short durations, this may cause the motor to stall. Furthermore, consistently subjecting the motor to torque spikes higher than its rating may reduce the motor's life span. This issue can be avoided or mitigated by selecting a motor with a rated torque higher or equal to the highest torque required to turn a standard operator gear. In one preferable embodiment, the motor should have a speed of at least 20 rotations per minute (RPM) to open a casement window.

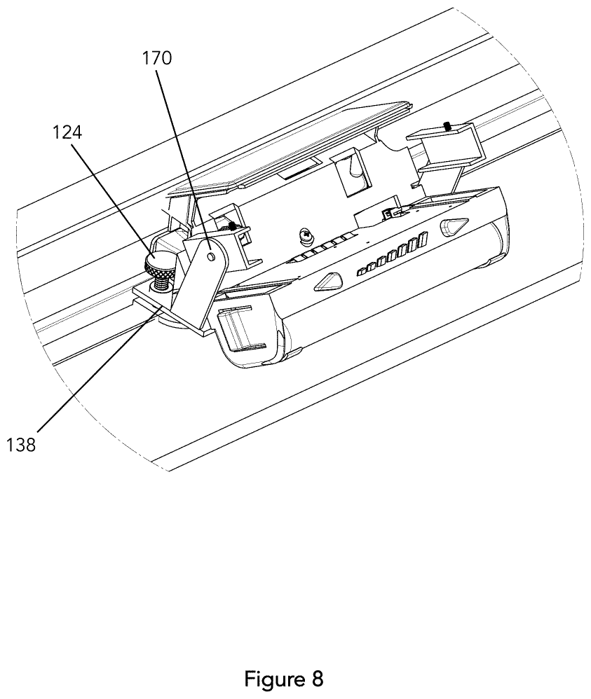

FIG. 8 is an isometric view of an installation clamp 138, which is shown as a universal installation clamp capable of securably clamping to operators having a variety of shapes and sizes known in the industry. At least one installation screw 124 attaches the installation clamp 138 to the chassis or housing of the solar powered window control device such that the solar powered window control device can be securably seated and mated with the installation clamp. Tightening the installation screw 124 clamps the installation clamp 138 to the casement operator. Preferably, and in the embodiment shown, the screw or other attachment mechanism secures the clamp to the casement operator in such a way that the installation clamp does not interact directly with the window frame or damage the operator in any way. The installation clamp 138 can further be securely and releasably attached to the chassis at an installation clamp chassis attachment site 170.

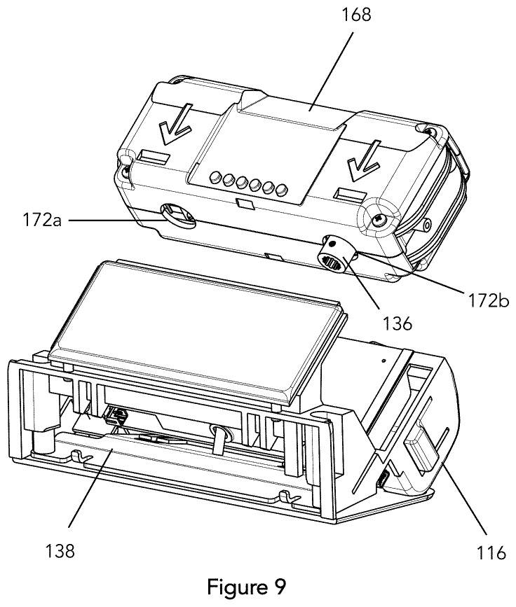

FIG. 9 is an isometric view of the rear of the window control device with detached motor housing. Casement window operators can be right-handed or left-handed, meaning that the turn direction (clockwise/counter-clockwise) can either open or close the window depending on the handedness of the operator. For this reason, the motor housing of the present design provides a changeable gear mechanism engagement such that the motor housing orientation and engaged spline shaft can be changed to accommodate both rotational orientations. Installation clamp 138 secures to the operator, and securably holds chassis 116 in place. Motor housing 168 is detachable from chassis 116 such that the orientation of the motor assembly and motor gear (not shown) inside the motor housing 168 can be changed to accommodate the rotation orientation of the window operator by engagement with a spline shaft 136. The spline shaft 136 can be engaged to the motor assembly through either of two motor housing apertures 172a, 172b and the motor assembly can be fitted into the chassis 116 such that the spline shaft 136 protrudes from one of the two motor housing apertures 172a, 172b for alignment and engagement with the operator gear.

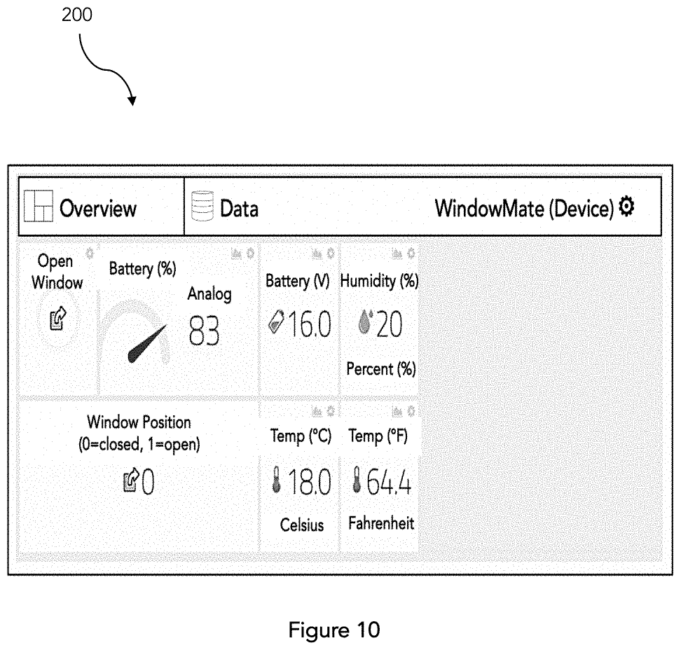

FIG. 10 is one example of a graphical user interface 200 on, for example, an app, computer display, thermostat display, or smarthome display, that can be used to monitor data from and issue instructions to the solar-powered window control device. The window device can be initiated using a standard internet-of-things (IoT) protocol with a wifi address and device authorization and connection to a peripheral control device with a wireless network connection and a processor. In a first initialization, a calibration procedure can be done to calibrate the window to the device so that the IoT system or smart thermostat can set the window open angle as desired. Data can be exchanged wirelessly with the solar-powered window control device via a wireless transceiver component of the solar-powered window control device, or via wired connection for example through a USB interface. Environmental information collected and optionally displayed on the interface 200 may comprise but is not limited to internal temperature, external temperature, light levels, humidity, rain, other weather readings, and other data. Device information collected and optionally displayed on the interface 200 can comprise but is not limited to battery condition, battery charge, battery charge rate, solar panel activity, window position, window direction, and other device information. Battery power can further be conserved by putting the window control device into a sleep mode when movement of the window is not required. By interacting with the interface 200, for example via a touch display, the user can change solar-powered window control device settings for example causing the window to open fully or by a specified intermediate amount, causing the window to close fully or by a specified amount, causing the window to operate in a specified manner according to a schedule, causing the window to operate in a specified manner according to sensor readings, or other instructions. Additional data, for example altitude, latitude, location of sun, time of year, season, weather, and other positional, climate, and geographic information may be inferred from sensor readings or acquired from other sources to inform window scheduling and automation.

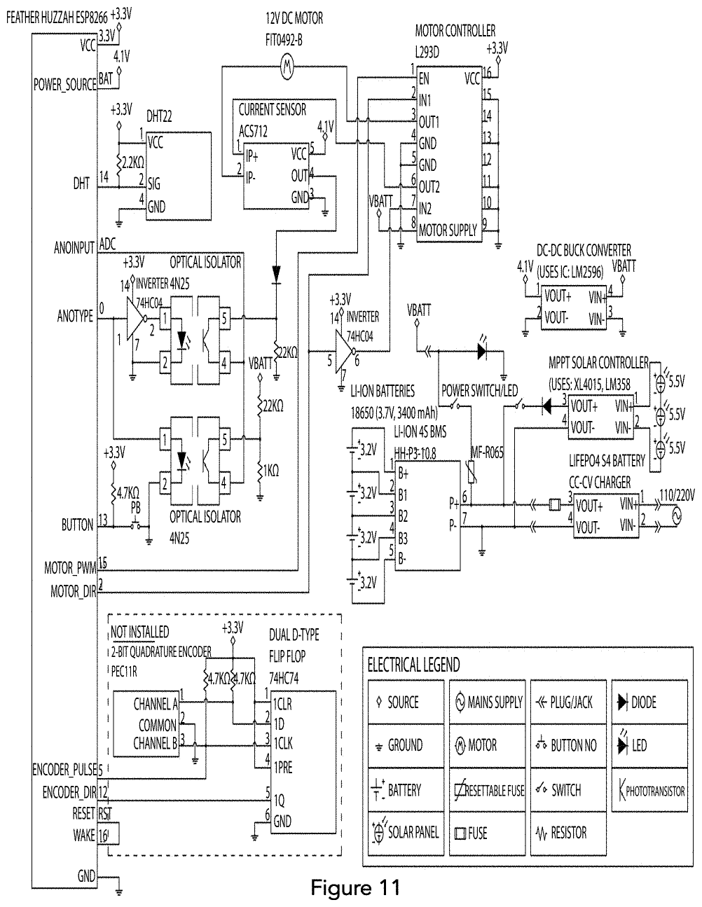

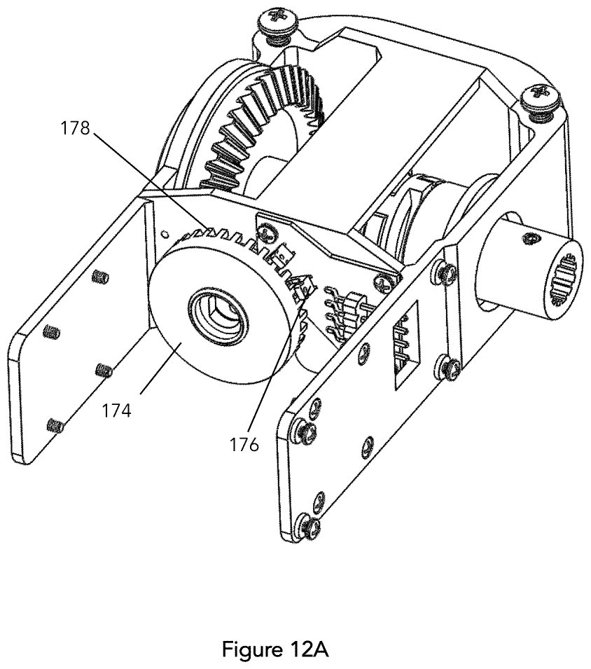

FIG. 11 is an example of an electrical schematic showing connectivity within the solar-powered window control device between the power sources (solar panel, battery housing, and/or AC adapter), motor controller, DC motor, sensors, and microcontroller. This illustration does not rule out other connections, or the addition or removal of specific elements for example sensors of various kinds. The current drawn by the motor increases with the demanded torque. A current sensor can be used to detect when the motor is operating a window that is fully open, fully closed, locked, or blocked. The motor's current detection is only necessary when the motor is running, accordingly the device could switch between monitoring the motor current, and the battery voltage. As illustrated in FIG. 10, a digital output can be used to activate one of two optocouplers, which act like electrical switches, one connected to the current sensor, and another to the battery voltage. The digital output controls which analog input is being received by the controller. Voltage dividers are used to scale down the incoming voltage from the battery, to prevent the analog input from exceeding 1V. A voltage drop is used to reduce the voltage from the current sensor. A battery management system (BMS) module can be used to keep batteries equally charged and within a safe voltage range. Li-ion battery cells can become damaged if over-discharged below 2.5V, and battery damage can be avoided by building a cut-off voltage circuit or implementing a compatible BMS module with over-discharge protection. A resettable fuse can be further added to the input/output of the BMS to protect the device from potential short circuits. A switch can also added to the output of the BMS to permit the battery pack to be disconnected and act as the power switch for the device to permit safe wiring, repairs, and storage. The switch can also be connected to an LED and/or to the microcontroller to indicate when the device turned on.

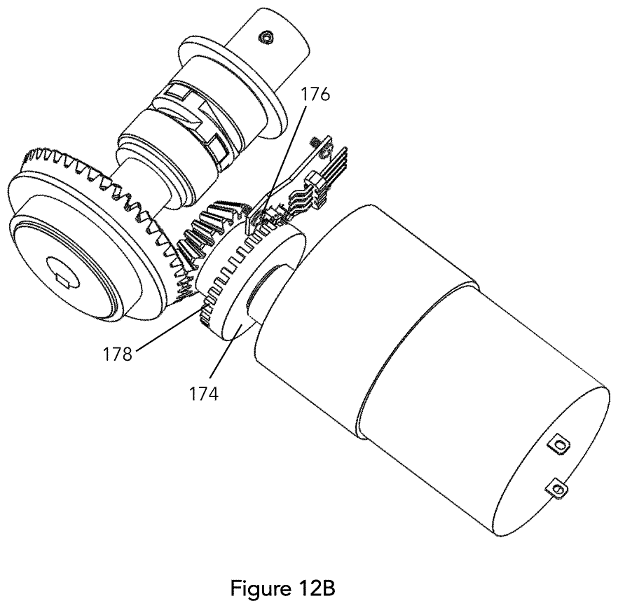

FIG. 12A is an isometric view of a bevel gear mechanism and window angle sensor. FIG. 12B is another isometric view of a bevel gear mechanism and window angle sensor without the casing. In the embodiment shown, encoder wheel 174 is positioned on the shaft out of the motor and before the beveled gear box. The encoder wheel 174 together with the optical sensor 176 read the angular position of the casement window and can discern the angle of the window relative to completely closed or completely open. The encoder wheel has a plurality of fine teeth that pass by optical sensor 176 as the beveled gear turns to open or close the window. Calibration of the geared window opening device is set by the number of teeth that pass the sensor between the full closed and full open position. To calibrate the optical sensor and window opening device, the window starts in a partially open position to calibrate the opener when it is installed on the crank. Using an input device either on the window opener, such as a manual controller, or through a remote control input via a processor and network connection, the opener is put into a calibration mode. In the calibration mode the window is first fully closed and then fully opened. During this process of window opening and closing the optical sensor 176 counts and records the number of teeth 178 which pass by the optical sensor during each transition of window angle. An algorithm is then used to calculate a virtual full open position. Preferably the calculated virtual full open position is slightly short of the true full open position to protect the window mechanism from being forced too far or beyond its the open position. Also, as the opener opens the window, the force required to open the window increases. The set virtual open position is used also to reduce the strain and power consumption on the opener.

Although the present description focused on the presently described device being useful in operating casement windows, it is understood that the same can be used for other applications in which it is desirable to have automatic gear control. Other applications can include but are not limited to awnings, pool covers, spa covers, exterior doors, and gear-driven window coverings.

All publications, patents and patent applications mentioned in this specification are indicative of the level of skill of those skilled in the art to which this invention pertains and are herein incorporated by reference. The invention being thus described, it will be obvious that the same may be varied in many ways. Such variations are not to be regarded as a departure from the scope of the invention, and all such modifications as would be obvious to one skilled in the art are intended to be included within the scope of the following claims.

We claim:

1. A device for adjusting the window angle of a casement window comprising:
a gear control mechanism comprising a spline shaft for engaging with an operator gear on a casement window;
a motor operably connected with the gear control mechanism to move the gear control mechanism and the operator gear to adjust a window angle of the casement window;
a photovoltaic cell for collecting sunlight;
a battery connected to the photovoltaic cell for storing energy produced by the photovoltaic cell and for powering the motor;
a microcontroller for controlling the motor; and
a wireless transceiver in communication with the microcontroller to direct the microcontroller to control the motor and adjust the window angle of the casement window.

2. The device of claim 1, further comprising one or more sensor operably connected to the microcontroller.

3. The device of claim 2, wherein the sensor is an indoor temperature sensor, outdoor temperature sensor, humidity sensor, light intensity sensor, window position sensor, window status sensor, or window obstruction sensor.

4. The device of claim 1, further comprising a screen displaying one or more of sensor output, battery status, window position, window status, outdoor temperature, indoor temperature, and weather.

5. The device of claim 1, wherein the device is a retrofit to an existing casement window.

6. The device of claim 1, further comprising a clamp for securing the device to a casement operator.

7. The device of claim 1, wherein the motor has a variable motor speed to apply varying torque to the gear control mechanism.

8. The device of claim 1, further comprising a current sensor to detect when a change in torque applied by the motor is required.

9. The device of claim 1, wherein the microcontroller is integrated with a smart-home technology through a local wireless network.

10. The device of claim 1, further comprising an AC power adaptor to charge the battery.

11. The device of claim 1, wherein the wireless transceiver operates using bluetooth, radiofrequency control, or remote data transmission.

12. The device of claim 1, wherein the gear control mechanism comprises two spline shaft engagement gears, one of the spline shaft engagement gears for controlling a clockwise-opening casement window and the other spline shaft engagement gear for controlling a counter-clockwise-opening casement window.

13. The device of claim 1, further comprising an encoder wheel and optical sensor for detecting the window angle.

14. A method of adjusting the angle of a casement window comprising:
collecting solar energy using a photovoltaic cell;
storing the collected solar energy in a battery;
coupling a gear control mechanism comprising a spline shaft with an operator gear on a casement window; and
powering a motor operably connected with the gear control mechanism to adjust the angle of the casement window.

15. The method of claim 14, further comprising detecting an environmental condition using a sensor and adjusting the angle of the casement window based on data detected by the sensor.

16. The method of claim 14, further comprising receiving weather data from a wireless network and adjusting the angle of the casement window based on the received weather data.

17. The method of claim 14, further comprising controlling the motor by sending a wireless signal to adjust the angle of the casement window.

18. A kit for retrofitting an existing casement window comprising:
a clamp for securably clamping to a casement window operator;
a spline shaft for engaging with an operator gear on the casement window;
a device for adjusting the angle of a casement window comprising:
a gear control mechanism for engaging with the spline shaft and the operator gear on the casement window;
a motor operably connected with the gear control mechanism;
a photovoltaic cell;
a battery connected to the photovoltaic cell for storing energy produced by the photovoltaic cell and for powering the motor;
a microcontroller for controlling the motor; and
a wireless transceiver in communication with the microcontroller to direct the microcontroller to control the motor and adjust the angle of the casement window.

19. The kit of claim 18, wherein the clamp is a universal clamp capable of adjusting to a plurality of sizes of casement window operators.

20. The kit of claim 18, further comprising a plurality of spline shafts for engaging with a variety of sizes of operator gear.
